(19) United States
(12) Patent Application Publication
(10) Pub. No.: US 2013/0172806 A1
(43) Pub. Date: Jul. 4, 2013

(54) METHOD AND DEVICE FOR PREPARING MEDICAL TREATMENT DEVICES

(71) Applicant: Fresenius Medical Care Deutschland GmbH, Bad Homburg (DE)

(72) Inventors: Erik GRIESSMANN, Schweinfurt (DE); Frank HEDMANN, Volkach (DE); Joachim WICH-HEITER, Kuernach (DE)

(73) Assignee: FRESENIUS MEDICAL CARE DEUTSCHLAND GMBH, Bad Homburg (DE)

(21) Appl. No.: 13/721,866

(22) Filed: Dec. 20, 2012

Related U.S. Application Data
(60) Provisional application No. 61/578,007, filed on Dec. 20, 2011.

(30) Foreign Application Priority Data
Dec. 20, 2011 (DE) 102011121668.9

(51) Int. Cl. G06F 19/00

(52) U.S. Cl. CPC G06F 19/3481
USPC 604/28; 705/2; 604/29

(57) ABSTRACT

The present invention is in the field of control of medical treatment devices, in particular devices for dialysis. The invention is based on the object of making the control of medical treatment devices more flexible and more convenient and expanding the possibility of programming and outputting individual action instructions. To do so, individual frontends are kept on hand for the treatment and for the medical treatment device, these frontends generating on external devices a phase list which is transferred to and then controls the medical treatment device.

### TECHNICAL FIELD

The invention relates to the field of preparation of medical treatment devices.

### STATE OF THE ART

Medical treatment devices include blood treatment devices in particular. Blood treatment devices comprise dialysis machines, which can be subdivided into hemodialysis machines and machines for performing automated peritoneal dialysis.

Dialysis is a process for purifying the blood of patients in acute or chronic renal failure. A fundamental differentiation is made here between methods using an extracorporeal blood circulation such as hemodialysis, hemofiltration or hemodiafiltration (hereinafter combined under the term “hemodialysis”) and peritoneal dialysis, which does not involve an extracorporeal blood circulation.

In hemodialysis, blood is conveyed in an extracorporeal circuit through the blood chamber of a dialyzer, which is separated from a dialysis fluid chamber by a semipermeable membrane. A dialysis fluid containing the blood electrolytes in a certain concentration flows through the dialysis fluid chamber. The substance concentration of the dialysis fluid corresponds to the concentration in the blood of a healthy person. During the treatment, the patient's blood and the dialysis fluid pass by on both sides of the membrane at a predetermined flow rate, usually in countercurrent. Substances that are usually eliminated in the urine diffuse through the membrane from the blood chamber into the chamber for dialysis fluid, while at the same time, electrolytes present in the blood and in the dialysis fluid diffuse from the chamber with the higher concentration into the chamber with the lower concentration. If a pressure gradient is established on the dialysis membrane from the blood side to the dialysate side, for example, by means of a pump which withdraws dialysate from the dialysate circulation downstream from the dialysis filter and the dialysate side, water will go through the dialysis membrane from the patient's blood into the dialysate circulation. This ultrafiltration process leads to the desired withdrawal of water from the patient's blood.

In hemofiltration, ultrafiltrate is withdrawn from the patient's blood by applying a transmembrane pressure in the dialyzer without passing dialysis fluid past the side of the membrane of the dialyzer opposite the patient's blood. In addition, a sterile and pyrogen-free substituate solution may be added to the patient blood. We speak of predilution or postdilution, depending on whether this substituate solution is added upstream or downstream from the dialyzer. Mass exchange occurs by convection in hemofiltration.

Hemodiafiltration combines the methods of hemodialysis and hemofiltration. A diffusive mass exchange takes place between the patient's blood and the dialysis fluid across the semipermeable membrane of a dialyzer and also the plasma water is filtered due to a pressure gradient on the membrane of the dialyzer.

Plasmapheresis is a method in which blood plasma is separated from corpuscular components of blood (cells). The blood plasma thereby separated is purified or replaced by a substitution solution and returned to the patient.

In peritoneal dialysis, the patient's abdominal cavity is filled with a dialysis fluid through a catheter passed through the abdominal wall, such that the dialysis fluid has a concentration gradient with respect to the endogenous fluids. The toxins present in the patient's body pass through the peritoneum, which functions as a membrane, and enter the abdominal cavity. After a few hours, the spent dialysis fluid in the patient's abdominal cavity is replaced. Water can go from the patient's blood through the peritoneum into the dialysis fluid by osmotic processes and can thus be removed from the patient.

This dialysis method is usually performed with the help of automatic dialysis machines such as the dialysis machine distributed by the applicant under the brand name 5008 or sleep.safe.

Automatic dialysis machines are microprocessor-controlled medical treatment devices. The treatment sequence is usually controlled by software. The user can often intervene in the treatment sequence by entering parameters via a user interface. Often a touchscreen display functions as the user interface.

The present invention is described below on the example of devices for automatic peritoneal dialysis as a representative embodiment of medical treatment devices. Additional medical treatment devices to which the invention can be applied include infusion equipment or heart-lung machines, for example.

In continuous ambulatory peritoneal dialysis (CAPD), dialysis fluid is conveyed from a film bag, usually under the influence of gravity, into the peritoneal cavity, i.e., the patient's abdominal cavity, through a permanently implanted peritoneal catheter and a transfer hose system. The dialysate remains in the abdominal cavity for several hours. After the end of this cycle, the dialysate is removed via the tube system. Automated equipment is not usually needed for this process.

However, a microprocessor-controlled machine is generally used in automatic peritoneal dialysis. Among other things, heating of the dialysate and its supply and removal are performed automatically in several cycles. To this end, such a device is equipped with valves, heating devices and pumps. In addition, it is possible to provide that such a device also automatically withdraws samples of the dialysis fluid flowing out and transfers them to certain sample containers, e.g., bags, intended for this purpose. Likewise, a machine for automatic peritoneal dialysis may be equipped with sensors, e.g., conductivity sensors or temperature sensors, for testing the dialysate flowing in and out, or pressure sensors for determining the intraperitoneal pressure.

Intraperitoneal pressure is understood to be the internal pressure in the peritoneum, which results from the fact that the abdominal cavity (peritoneal cavity) is filled with dialysate and a counterpressure is exerted on the peritoneum and may in turn be used to determine the ideal degree of filling for each individual patient. Providing the pressure-measuring device allows pressure-controlled filling of the abdominal cavity by utilizing the individual volume available.

The peritoneal dialysis sequence is variable individually for each patient and is specified by the physician. Such medical treatment instructions comprise a prescription.

A prescription often includes cyclic operations. A single cycle is often determined by the following parameters:
type, quantity and temperature of the dialysis fluid flowing in,
dwell time of the dialysis fluid in the peritoneal cavity,
outflow rate in removal of the dialysis fluid from the peritoneal cavity,
sampling and analysis of the sample.

The number of cycles may vary, and different parameters may apply for each individual cycle. It should be pointed out that treatments with other embodiments for the medical treatment devices may be subject to different sequences.

It is often desirable to give instructions to a patient during a treatment or to issue messages or to allow an interaction with the patient, for example, by having a patient select and/or enter possible responses to certain questions that are output. This type of input and output of information during a treatment is referred to as a communication phase in the sense of the present invention and has not previously been provided in the state of the art in this way.

A user interface inside the device, often embodied as a touchscreen, is used to enter the parameters into a dialysis machine. For example, DE 2010 000 5745 describes a machine for automatic peritoneal dialysis having a touchscreen as a user interface. Specific entry programs (hereinafter referred to as frontends) are used here for programming the treatment sequences of the medical devices themselves; these programs often have limited user convenience and restricted flexibility in comparison with conventional programs run on personal computers. The user here can program the sequence of the treatment, for example, by parameterizing certain predetermined parameter keys. Parameter keys are assigned to certain processes in the treatment sequence. For example, the parameter key “initial_rain” may be assigned to the operation “initial removal of the dialysis fluid from the peritoneal cavity.” By assigning a parameter value to a parameter key, the description of a certain treatment phase is completed. Thus, for example, the parameter value 2,000,000 (μL) may be assigned to the parameter key (initial_drain), which means that the volume of the outgoing dialysate should be 2 liters.

A frontend in the sense of this invention is understood to be an input option for certain parameter keys and parameter values embodied in the form of software, comprising an integrated interpreter program, which generates a phase list that can be processed for the medical device from the inputs. A phase list describes the chronological sequence of a treatment and defines the periods of time during which the medical device should perform certain actions. The treatment sequence is often variable on the basis of certain fixed predetermined sequences, in which certain parameter values, for example, the duration of a certain phase, are assigned to the fixed predetermined sequences.

In peritoneal dialysis in practice, one finds not only simple treatment sequences (cycle-based treatments) but also very complex treatment sequences (e.g., different profiles for each treatment phase). It is very tedious to program such complex treatment sequences using the standard frontends, which are kept on hand in medical devices, in particular the devices for automatic peritoneal dialysis. Although it is fundamentally possible to replace the standard frontends in medical devices with new more highly developed frontends, this necessitates the employment of service technicians, which can be complicated and expensive. The user is prohibited from installing software on medical devices himself for safety reasons. In the case of automatic peritoneal dialysis machines, such an update by a service technician would be enormously complex and cost-intensive because there are thousands of devices for patients who must rely on dialysis and often use such a machine at home.

Another aspect of preparation of medical devices comprises the programming of standardized tests. Such tests are used to obtain medical data on the patient and comprise standardized treatment steps. For example, a so-called PE test (peritoneal equilibration test) for peritoneal dialysis comprises cycles of a predetermined duration during which a predetermined volume of dialysis is added to or removed from the patient's peritoneal cavity, so that blood samples and/or dialysate samples are taken from the patient at certain times and then tested using laboratory technology. These PE tests are differentiated according to the total duration, i.e., there are short and long PE tests. The results of such PE tests provide information about the residual renal function, the filter function of the peritoneum and the dialysis response of the respective patient and may lead to a corresponding individual prescription. The state of the art does not yet provide for simple programming of such tests and in particular the use of such tests with the communication phase described above.

### DETAILED DESCRIPTION OF THE INVENTION

The object of the invention is therefore to make the preparation of medical treatment devices more flexible and more convenient and to expand the possibility of programming and outputting individual communication phases. In addition, the programming and preparation of medical tests, in particular PE tests, should be simplified.

According to the invention, this object is achieved by the method of claim 1 and the devices of claims 16, 7 and 20. Advantageous embodiments are the subject matter of the dependent claims.

Preparation of the medical treatment device, in particular a machine for automatic peritoneal dialysis, is understood to refer in particular to setting the time sequence of a subsequent treatment. This sequence is usually set by a physician, so the physician prescribes an individual treatment sequence for a certain patient, which necessitates an individual configuration of the medical device.

This configuration of the medical device is always performed prior to the treatment. It can also be stored in the device for multiple treatments, because they usually change only rarely, and selected at the time of the treatment. It is essential that the configuration of the medical device does not mean the start of the treatment but instead only determines the sequence of a subsequent treatment.

To convert a medical treatment prescription into a configuration of a medical device, several frontends are kept on hand according to the invention. These frontends comprise input options for certain parameter keys implemented as software along with the parameter values assigned to them. Each frontend has an integrated interpreter program, which converts the entries into a phase list that configures the medical device and can be processed by the medical device. The frontend and the interpreter program together form a function unit. One or more frontends may be stored as a computer program product in any memory medium and distributed in any desired manner, for example, as data files on a USB stick or as files downloaded from a server. The computer program product, operated on any microprocessor, can thereby execute the method steps described here.

The numerous frontends differ in at least one of a number of features, where the features may comprise the type of medical treatment device, the purpose of the treatment, the location of the treatment and/or the user of the frontend. For clear-cut identification of the frontend, a frontend identification number (frontend ID) may be allocated to each frontend.

Input of multiple parameter key/parameter value pairs into a frontend forms a model for the sequence of treatment or for the sequence of a phase of treatment.

Table 1 shows an example of the input options (parameter key) of a frontend of a machine for automatic peritoneal dialysis with the exemplary frontend ID 1.

TABLE 1
List of input options of the frontend with frontend ID 1.

| | Parameter | | |
|---|---|---|---|
| Parameter key | value | Unit | Comments |
| fill_sol_id | 13 | solution | type of solution of the filling |
| | | ID | phase |
| initial_drain | 100000 | μL | drain volume for the initial |
| | | | drain |
| last_fill_sol_id | 13 | solution | type of solution of the last fill |
| | | ID | |
| last_fill_vol | 0 | μL | filling volume of the last fill |
| max_fill_vol | 2000000 | μL | max. volume for a fill |
| total_duration | 7200 | sec | treatment duration |
| total_fill_vol | 4000000 | μL | total solution volume of the |
| | | | treatment |
| pet_short | event_name | | short PE test with retrieval |
| | | | of the communication |
| | | | phase subroutine |
| pet_long | event_name | | long PE test with retrieval |
| | | | of the communication |
| | | | phase subroutine |
| event | name | | communication phase “name” |

The user entering the prescription into the frontend then selects from the list of possible entries (parameter keys) those corresponding to the prescription and assigns parameter values to them in accordance with the prescription. Thus this yields a model of the prescription which can be stored as a text file.

An interpreter belonging to the frontend determines a corresponding phase list from the specific entries in this text file. The phase list here describes the sequence of phases, whereby an unambiguous configuration which is delineated in time and is assigned to the corresponding device is intended as the phase. Such a phase is defined, for example, by the period of time and the valid configuration therein, during which the device pumps dialysate out of the patient's peritoneal cavity. A phase sequence corresponding to the treatment model can be determined in this way from the total treatment duration, the total treatment volume and the available dialysis solutions, as shown in Table 2.

TABLE 2

| Phase | Drain volume | Duration | Fill volume |
|---|---|---|---|
| drain phase | 100 mL | | |
| fill phase | | | 2000 mL |
| dwell phase | | 60 min | |
| drain phase | pressure-controlled | pressure-dependent | |
| fill phase | | | 2000 mL |
| dwell phase | | 60 min | |
| drain phase | pressure-controlled | pressure-dependent | |

This list can also be stored in a data file. The two lists are advantageously stored in one data file.

The frontend and the integrated interpreter are often part of the medical device. Entries are made accordingly via the user interface, which is often embodied as a touchscreen display. Changes in the frontend itself, for example, an update of the software or addition of parameter keys cannot be implemented without a substantial intervention into the medical technical device. New software must therefore be installed in each medical device, but as a rule, this can and should be performed only by technically trained service personnel.

In addition, the frontends are also individualized regionally, for example, with regard to the language used and also with regard to the possible parameter keys. For example, the case may be that certain prescriptions are allowed in one country but are not allowed in another country, for example, for approval reasons or because this specific treatment is not covered by the medical insurance companies there. Consequently, the medical devices must be equipped with individual frontend software for each country, which means a high production complexity.

In addition, another difference may consist of whether the frontends should be allowed for patient use or whether they are directed at skilled medical or technical personnel. Accordingly, frontends for patients may be equipped with a restricted functionality and/or layout, and/or frontends for medical or technical personnel may be equipped with an expanded functionality and/or layout.

Another differentiating feature for the frontends to be selected may also be whether the device is used in a medical environment (doctor's office or dialysis practice, hospital, university), at home or in a technical service environment.

There is thus a wide variety of individual frontends with which each device can be equipped. This individual equipment of a variety of devices with the frontends provided there, which may also vary in numerous ways, entails a high complexity in terms of manufacturing and logistics.

According to the invention, this disadvantage is overcome in that a plurality of frontends having freely selectable parameter key sets for preferred use in external devices can be kept on hand or generated, their integrated interpreters converting the respective parameter keys into a phase list that can always be processed by the respective medical device. The language of the user interface of the frontend can be selected freely.

The external device is preferably a device comprising a microprocessor unit, an input device and an interface for technical data communication with external memory media, wherein the microprocessor unit, the input device and interface are interlinked for data communication. The interface for technical data communication with external memory media may be, for example, a USB port, to read and write to USB sticks. However, any other interface which is suitable for addressing external memory media, in particular also interfaces that can read and write to patient cards, may also be used.

In the sense of the invention, all devices comprising a microprocessor unit, an input device and an interface for technical data communication with external memory media are disclosed explicitly, wherein the processor unit, the input device and the interface are interconnected for data communication, their microprocessor unit being programmed so that it can execute the processes claimed in the claims.

Patient cards are cards that are unambiguously assigned to a certain patient and having a readable and writable memory on which treatment data can be stored, such as the prescription by a dialysis physician, for example. According to the invention, the configuration file generated by the frontend and the integrated interpreter can be stored on this card. Patient cards may also be so-called smart cards, which also comprise a microprocessor in addition to the memory.

A patient card may also be embodied so that it has a plurality of different interfaces for communication with external devices. For example, a patient card may have an interface which operates according to the Inter-Integrated Circuit (I2C) data transmission protocol and has a corresponding contact configuration for exchanging data with an external device and additionally has at least one interface which operates according to another data transmission protocol and/or another contact configuration. For example, parallel data transmission protocols, Bluetooth or other radio-based data transmission protocols, magnetic strips, chip module contact surfaces and the like are also conceivable here. A patient card implemented in this way can be used universally and may advantageously be used in multiple devices, even when these devices have different interfaces among one another and/or have different data transmission protocols for communication with the patient card.

Over a period of time, for example, it may happen that a patient may change which medical device he uses for a treatment or he must temporarily use a different medical device than the device he normally uses, for example, during a trip. However, the different medical devices are not necessarily equipped with the same interfaces and/or data transmission protocols. A patient card having a plurality of interfaces and/or data transmission protocols can advantageously communicate with different medical devices in such a situation and can facilitate the treatment.

However, external memory media may also include memories in the medical device itself. An interface for contacting these memories may be, for example, a network interface, which may be hardwired or wireless. In this way, the external device can store the configuration file generated by the frontend and the integrated interpreter directly in the memory of the medical device to be configured.

The external device which executes the frontend and the integrated interpreter is often a so-called personal computer. Personal computers are understood in this context to be stationary desktop computers or mobile devices such as laptops, netbooks or the like.

It is also conceivable for the external device to be a smartphone or a notepad. In addition, the external device may also be a combination of a terminal and a central device on which the frontend and the integrated interpreter are executed and by which the terminal is addressed.

If the frontend ID of the configuration file is identical to the frontend ID of the frontend stored in the medical device, this does not yield a difference between the parameter lists, which have been generated for the same prescription of the internal frontend, and the parameter list generated by the identical frontend on an external device. The internal interpreter could convert this parameter list to a phase list, for example, if the phase list to be entered cannot be read correctly.

An important advantage of the invention is the separation between the parameterized parameter key list and the phase list generated from the former. Although the parameterized parameter key list is independent of the medical device and is generated by the respective frontend, the phase list is characteristic of the medical device. This means that the integrated interpreter converts the parameterized parameter key list into a phase list, which the medical device to be configured is always capable of processing. The interpreter operates to a certain extent as a translator between the (highly developed) frontend language, whose vocabulary corresponds to the totality of all possible parameter keys and parameter values, and the language of the medical device.

It is possible that instead of the phase list, a machine-readable code is generated by the interpreter as a text file and is transferred in the same way to the medical device. The advantage of such an approach is that microprocessor-controlled machines such as those that are customary with medical devices can be programmed directly by a machine-readable code without the need for an operating system to convert a text file into a machine-readable code. This conversion of a test file, for example, a phase list, into a machine-readable code is often subject to restrictions on the operating system. This may apply in particular to software-controlled medical devices. These restrictions may be prevented by having the machine-readable code not generated in the medical device itself but instead by more highly developed programs, which are executed on external devices.

According to another embodiment of the invention, frontends having graphical user interfaces are to be used. Graphical user interfaces for generating flowcharts are well known in the technical world. Instead of entering cryptic text commands, with a graphical input, the user selects symbols which describe a corresponding action. For example, instead of entering the command “initial_drain(100000)” into a text editor of a frontend, a symbol, e.g., a rectangle having a corresponding symbol, may be selected and linked to other symbols, for example, by a connection to a line. A corresponding parameter value may be assigned to each symbol, for example, by a mouse click and corresponding input of the parameter value.

According to another embodiment of the invention, the phase list is expanded by a phase of the output of messages preferably addressed to the patient (communication phase). Of the messages addressed to the patient, these include outputs onto a display screen, other optical signals such as lamps, haptic signals, for example, vibrations of suitable devices or acoustic signals such as tones or speech output via loudspeaker.

The internal frontends of the medical devices, in particular devices for automatic peritoneal dialysis, have so far not offered the opportunity of programming freely selectable, messages which are to be output by the display device of the medical device. Such messages include, for example, text messages which are displayed on a screen. It may be advantageous to transmit certain messages to the patient for treatment by a medical device. In peritoneal dialysis, for example, the patient may be instructed to lie down or to stand up. In addition, the patient may be instructed to take a certain medication. Such messages may be based on a prescription or they may be independent of measured values, for example, measured patient values such as blood pressure, body temperature, pulse rate or the like, which are determined by the medical device during the treatment or are sent to the medical device. It is possible to provide for certain messages to request input by the patient; for example, the message instructing the patient to take a certain medication may also instruct the patient to confirm on the device that he has successfully taken the medication. This may be accomplished, for example, by operating a certain user input option such as depressing a certain key or touching a certain area of a touchscreen display.

It is also conceivable that in the case when certain measured values exceed limit values, the medical device does not just output a message to the patient but alternatively may also send an alarm to professional medical personnel via communication means that are provided. Said communication means comprise, for example, pager messages, SMS messages or email communication. In addition, in the event certain measured values exceed limit values, the medical device may intervene in the treatment sequence and may speed up or delay the treatment, for example.

At least one additional key parameter (“event” for example) is assigned to the communication phase. The parameter value may be the message which should be output, for example, freely selectable text. The text is preferably written by professional medical personnel. It is possible to provide for the message of the communication phase to be displayed until the patient has confirmed the message. It is also possible to provide for the message to be displayed only for a defined period of time. However, the parameter value can also refer to a file, which initiates a plurality of information output and/or information input into the medical device.

For example, the communication phase may comprise the output of graphics, sounds such as music or voice output, animation or video. Furthermore, it is provided that information is also compiled in the communication phase. Such information may include manual entries by the operator or the patient. These entries may be made through suitable input means, for example, keyboards, touchscreens or the like. Audio recordings for input of spoken and/or acoustic information, video recordings for input of visual information or measured values, which may preferably comprise physiological parameters of a patient such as body temperature, body weight or blood pressure are also conceivable. Sensors such as microphones, cameras, temperature sensors, scales or blood pressure sensors which may be provided on the medical device are preferably used for this purpose.

Due to the possibility of information input and output during the communication phase, there may be a dialogue between the person and the device which offers a variety of possible options.

An especially advantageous application is for documentation of a treatment. The technical treatment parameters, which may be described by the phase list, and the response of the patient, which may be included in the communication phase are both documented here. For example, the patient may be asked about his subjective well-being in the communication phase, for example, by output of the message “How do you feel?” (visually or acoustically). Then the patient has an opportunity to respond to this question. This may be done by selecting a prefabricated response, for example, by selecting a corresponding possible answer, which is displayed on a touchscreen. It is also possible to allow the patient's individual responses to be entered as text input via a keyboard, for example, which may also be a virtual keyboard on a touchscreen. Moreover, it is possible to provide for the patient to be able to respond in his own language. Voice input is made here by means of an audio recording.

Regardless of how the patient's response is documented, it is important for the response to be assigned to the patient and the treatment circumstances unambiguously. This includes not only storing the treatment parameters and storing at least one patient identification feature such as a patient number but also input of the precise date and time when the response is given. The assignment of an anonymous identification feature to a specific patient is advantageous in particular when anonymized medical studies are conducted. However, the patient's name may also be stored.

The resulting data record is stored in a suitable means. Such means may comprise conventional memory media such as hard drives, USB sticks or the like, as well as the use of patient cards or sending the data to remove devices such as servers or smartphones. By transferring the treatment documentation to the treating physician, for example, a medical report is prepared, which makes it possible for the treating physician to conveniently evaluate the patient's treatment and to optionally alter the prescription for the next treatment depending on the result. This prescription may be issued conveniently by using an external frontend at the physician's office in the manner already described. Next, a phase list corresponding to the new prescription can be transferred to the corresponding medical device.

The treatment can be improved in a particularly advantageous manner through this new possibility of interaction between the treating physician and the patient regarding the use of external frontends and the introduction of a communication phase. Thanks to the communication phase, the patient may even record his impressions directly in his own words by making audio recordings during the treatment without any tedious text input; this is advantageous in particular if the treatment is performed while the patient is lying down or on people who cannot read or write. This ensures that each detail about the patient's well-being is documented although it might otherwise be forgotten in a discussion with the treating physician a few days or hours after the treatment. It is also advantageous that the physician is able to adjust the prescription promptly. Especially in the case of peritoneal dialysis which is performed each day, the physician can thus respond promptly to the patient's feedback, which is documented by the communication phase, although this could usually be done only much later during a doctor's visit. The safety and comfort of the treatment are significantly improved in this way.

The embodiments of the present invention are explained in greater detailed in the detailed description of the figures.

### BRIEF DESCRIPTION OF THE FIGURES

Examples of embodiments of the present invention are described below on the basis of the following figures:

FIG. 1 shows schematically a medical device embodied as a machine for automatic peritoneal dialysis, and a device according to the invention embodied as a desktop computer for generating a parameter key list and a phase list;

FIG. 2 shows schematically the exemplary image content of a display screen of a device which executes an inventive frontend that processes text input;

FIG. 3 shows schematically the exemplary image content of a display screen of a device which executes an inventive frontend that also processes symbolic input;

FIG. 4 shows schematically a diagram representing the sequence of a PE test.

### DETAILED DESCRIPTION OF THE FIGURES

The present invention is described in detail below with reference to the figures. The same reference numerals are used for the same components.

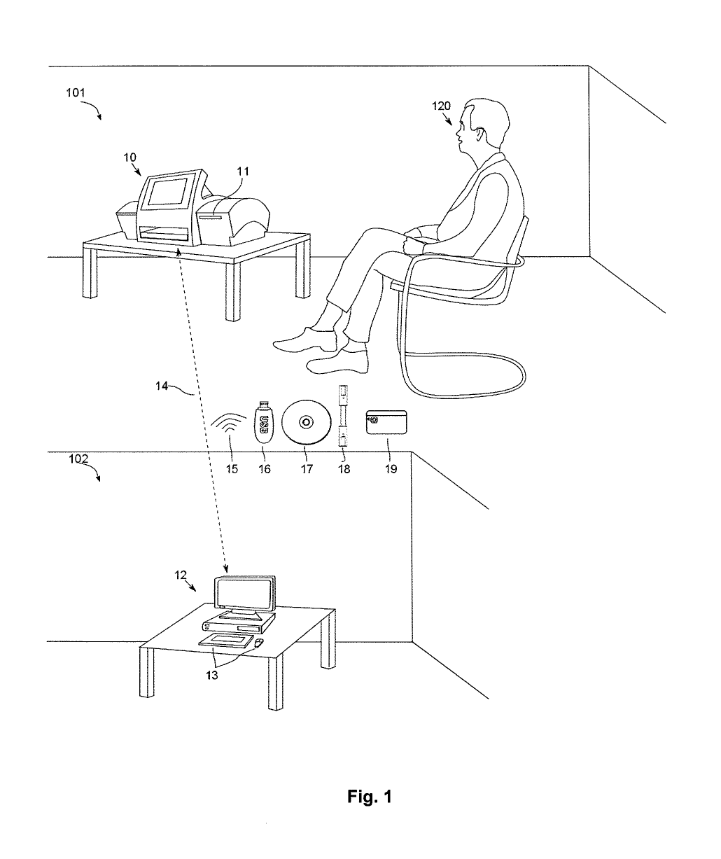

FIG. 1 shows schematically a device 10 for automatic peritoneal dialysis and an eternal device 12, embodied here as a desktop computer, for generating a parameter key list and a phase list according to the invention. The patient 120 is often at home. Patient 120 and the device 10 for automatic peritoneal dialysis interact during the treatment through tubing systems (not shown in FIG. 1). However, the core of the invention is not the treatment itself but instead its preparation. Consequently, FIG. 1 does not show any treatment situation.

It is important that the medical device 11 and the external device 12 need not be situated close to one another. This is indicated by the different rooms 101 and 102 in FIG. 1. The external device 12 may be present in a medical environment, for example, in a clinic, in a doctor's practice or in a university. However, the location of the external device 12 does not play any role. The programming of a prescription is thus independent of the presence of the medical device itself.

In the embodiment illustrated in FIG. 1, the external device 12 is equipped with multiple input devices 13. These input devices in FIG. 1 comprise a computer keyboard and a computer mouse. Such input devices, which are customary with computers, are more convenient than a touchscreen, such as that often used for input on medical devices.

The parameter key list and the phase list are generated according to the invention on the external device 12. A frontend is used for this purpose according to the invention. The two lists may be stored in one or more data files. It is also possible for a machine-readable code (for example, HEX code for microprocessors) to be generated with the external device 12 and stored.

The stored lists and/or the stored machine-readable code is/are transmitted from the external device 12 to the device 10. This is indicated by a dotted double arrow 14 in FIG. 1. Moreover, there is also an embodiment in which data can also be transmitted from the device 10 to the device 12, e.g., measured values detected during a dialysis treatment, or device-specific data, for example, the parameter key list and/or phase list currently in use.

To this end, the two devices 10 and 12 are equipped with interfaces, of which only the interface 11 for communicating with a patient card is diagrammed schematically in FIG. 1.

There are various possibilities of data exchange between the devices 10 and 12, some of which are represented as examples in FIG. 1. The arcs 15 stand for wireless data communication, for example, WLAN, mobile wireless, Bluetooth, infrared or the like or similar non-hardwired communication methods. A portable rewritable memory medium 16 is implemented as a USB stick, for example. Alternatively, there is an optical memory medium 17, that can be implemented here as a writable compact disc. Additional possibilities of data transmission are represented by a network cable 18, which symbolizes hardwired communication such as LAN or Internet communication and by a patient card 19 equipped with at least one readable and writable nonvolatile memory (for example, EEPROM). It is not matter for the present invention how the data is exchanged among the devices. Instead, it is important only that the devices are equipped for this.

The data communication methods which are symbolized in FIG. 1 by the symbols 15 through 19 enable remote programming of the medical device, which is embodied in FIG. 1 as a machine for automatic peritoneal dialysis.

The device 11 for automatic peritoneal dialysis is advantageously located in the patient's home. However, a professional technician is required to program the controller of the device 11. If the programming must be performed on the device itself, this means that the service technician must go to the patient's house or that the device itself must be taken to a skilled person.

Through the use of external frontends, the programming of the controller of the medical device 11 may be performed at a remote site. The transfer of programming may be performed by using network communication methods (15, 19 in FIG. 1) without the input of a person who must operate the device directly. However, the transfer of the programming may also be done by the patient 120 himself by making available the corresponding memory medium (e.g., 16, 17 and 19) to the interface (for example, 11 in FIG. 1) provided for this purpose.

The medical device 12 may be equipped so that it recognizes automatically that a new parameter key list, a new phase list or a machine-readable code is available, which is stored on a memory medium which communicates currently with one of its interfaces (for example, 11 in FIG. 1). It may instruct that the transfer of the new prescription which is written by the parameter key list, the new phase list for the machine-readable code, be confirmed by an output on an output device, for example, which may be embodied as a touchscreen with a corresponding confirmation button or a touch surface, which must be operated for the confirmation. The medical device 12 may, however, also be equipped so that it transfers a prescription which has been made as such in a known way without further manipulation.

In any case, care is taken to ensure that a prescription cannot endanger the patient. To this end, various tests may be performed on the prescription, for example, by checking on whether the temperature of the dialysate flowing into the machine is within a certain range that is not harmful to the health of the patient. It is also possible to ensure that a patient is not overfilled. Overfilled here means that such a large volume of dialysis fluid is infused into the patient in a treatment phase that he cannot receive it without harm due to his body size.

Such individual patient limit values are known to the medical device, for example, by reading the patient card on which these limit values may be stored. Furthermore, such individual patient limit values may be made known to the machine in any desired manner, for example, by authentication of the patient via a fingerprint sensor, an iris scan or by input of secret passwords which identify the patient and then loading the patient limit values out of any memory which is kept on hand, for example, an internal memory or an external memory that can be reached by data communication via a network, for example.

In addition, it is also conceivable that a software-based simulation of the device is used for evaluating the programming of the medical device. Such a software-based simulation of the medical device simulates the behavior of the device one-to-one. Thus, the behavior of the device can be tested by a new prescription without the device that is to be programmed being present. This requires precise modeling of the medical device to be simulated.

It is also conceivable that not only the device to be programmed is replaced by a software-based simulation but also the patient himself is replaced by a simulation. Modeling of a patient is comparatively complex and inaccurate. Nevertheless, with the help of a virtual patient, the effect of a prescription can be tested easily and safely, at least on an approximate level. This is advantageous in testing new medical devices and in conducting medical studies in particular.

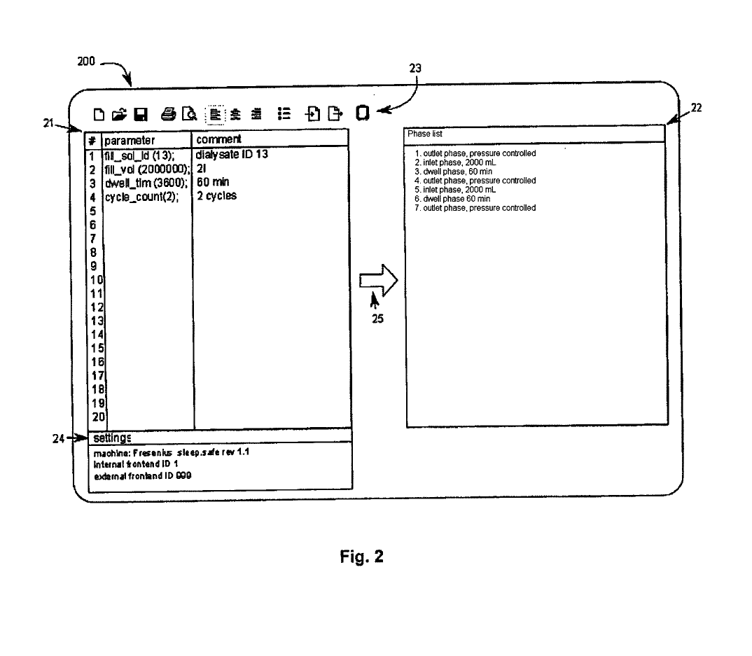

FIG. 2 shows as an example a typical screenshot of an external device on which a frontend, which is specific for a certain medical device, is implemented. FIG. 2 shows in detail a screenshot 200 with the frontend opened. This frontend program offers two text input and output windows 21 and 22. One window 24 (“settings”) shows information about the medical device to be programmed (Fresenius Medical Care sleep.safe in embodiment 1.1 in FIG. 2), the frontend present in this device (the frontend with the frontend identification number 1 in FIG. 2) and the external frontend currently selected (the frontend with the frontend identification number 999 in FIG. 2):

Various operations such as save, open, print, etc. can be selected by clicking on a menu list 23.

The user can enter a parameter key list corresponding to the prescription at least in the window 21. The “#” field here is used for the numbering of the rows, while the corresponding parameter keys with the following parameter value in parentheses are entered in the “parameter” field and finished with a semicolon. This notation is given only as an example, and any notation is conceivable for input of the parameter keys and the parameter values. The “comment” field is used for entering any desired commentary.

By depressing the arrow 25 shown in FIG. 1, the interpreter which supports the frontend from the parameter key list generates a phase list and displays it in window 22. The interpreter takes into account the data given in window 24 which must be entered by the user. Thus, the example in FIG. 2 shows that the internal frontend has a different frontend identification number (ID 1) than the frontend currently in use (999). The entries in window 21 therefore cannot be entered into the internal frontend because the latter has an inadequate parameter key set. The interpreter generates a phase list (in window 22) from the entries in window 21 and the knowledge of the device to be programmed, and the device to be programmed can receive this phase list with no errors. Alternatively, and not shown in FIG. 1, the interpreter may also generate a machine-readable code (hex code) which can be received with no errors by the device to be programmed.

According to another embodiment of the invention, the frontend program checks at the time of entry of the parameter key list on whether the entry is implementing a prescription which would violate safety rules. For example, the frontend program could check on whether the fluid volume flowing into the patient is within previously defined limit values. It is also conceivable that the identity of the patient and/or patient individual limit values for certain parameter values are disclosed to the external frontend program. The frontend program can then check the prescription entered for whether it complies with the patient-individual limit values and may output a warning if necessary.

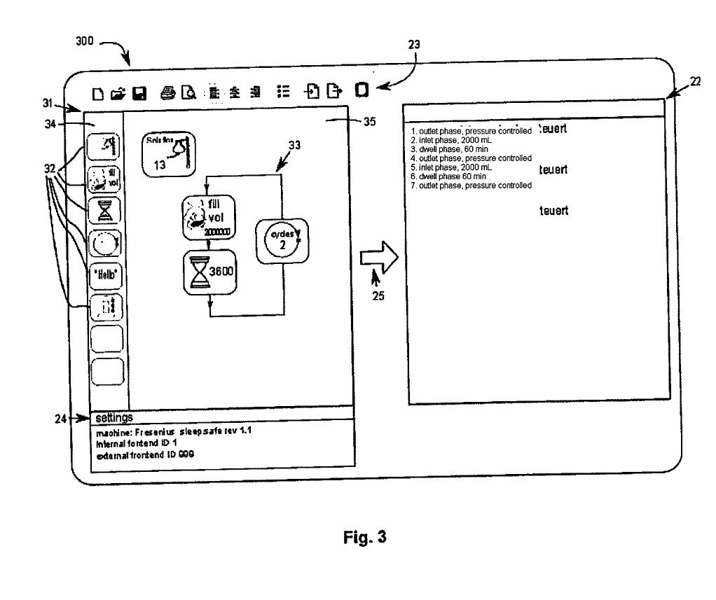

FIG. 3 illustrates another embodiment of the invention where the prescription is entered by graphical symbols. The window 31 here is subdivided into a selection area 34 and a clipboard area 35. Various symbols 32 are shown in the selection area; these symbols may be selected using a computer mouse, for example, and pulled into the deposit area. Parameter values can be assigned to these symbols which stand for corresponding parameter keys, in the deposit area, for example, by right-clicking with a computer mouse and then entering a parameter value on the keyboard. Similar operating concepts are known of circuit simulation programs, for example. The sequence of the prescription is determined via freely generable connections 33 between the symbols.

The example in FIG. 3 shows the graphical correspondence of the parameter key list shown in FIG. 2.

The “solution” symbol is parameterized with the value 13. Since this symbol stands only for the dialysis fluid to be used, there are no links to the other symbols. The “fill vol” symbol has the parameter value 2,000,000 (μL), which stands for a filling volume of 2 liters. The symbol, which has an hourglass, has the value 3600 (s), which means that the dialysis fluid should remain in the patient for 60 minutes and should then be removed from the patient. The symbol “cycles” has a value of 2, which stands for performing it twice. The symbols are linked to one another with lines having arrows in accordance with the prescription. This method of entering a prescription is very convenient. The user need not know any cryptic parameter keys. Instead of writing a parameter key list, the user prepares a graphical correspondence. The process of translating the graphical correspondence into a phase list proceeds like that already explained in the description of FIG. 2. Moreover, according to one embodiment of the invention, in addition to the phase list, a parameter key list can also be generated from the graphical correspondence. A variety of other embodiments are also conceivable for the graphical generation of a prescription; FIG. 3 shows only one example of this.

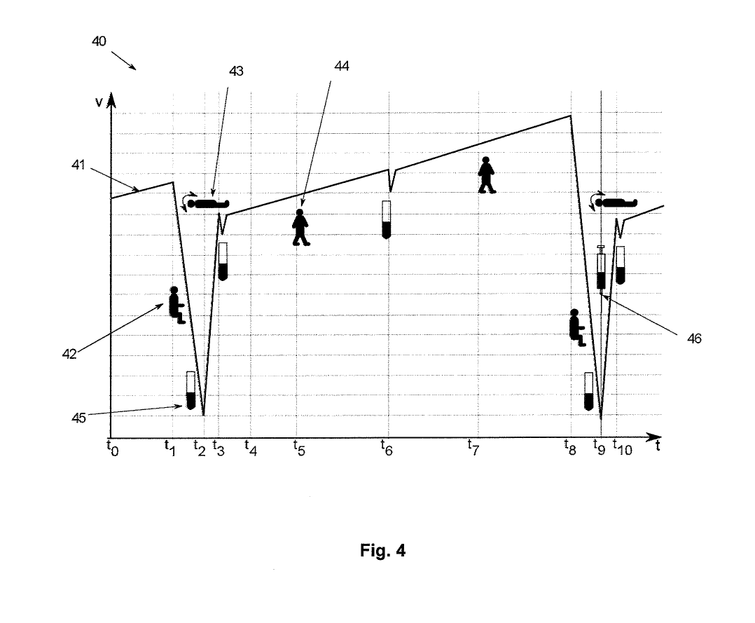

FIG. 4 shows as an example the course of a PE test on the basis of a diagram 40, which plots the filling volume 41 in the peritoneal space as a function of time. The symbol 42 here denotes the instruction to the patient to sit down, while 43 indicates the instruction for the patient to roll over each way while lying down to distribute the dialysate and the symbol 44 instructs the patient to walk a few steps. The symbol 45 stands for the fact that a sample of the dialysate present in the peritoneal space should be taken and the symbol 46 illustrates that a blood sample is to be taken.

The curve 42 of the filling volume in the peritoneal space is typical of a PE test for peritoneal dialysis. The patient arrives for treatment with a filled peritoneal space at time t0. At time t1 the PE test starts. The increase in filling volume is attributed to the intended property of the glucose-based dialysate of removing water from the patient. Consequently, the filling volume in the peritoneal space increases over time if dialysate containing glucose is present in in the patient. At time t1, the peritoneal space is emptied while the patient is sitting and a sample of the dialysate flowing out is taken and then tested in the laboratory. This operation lasts until time t2, which is followed by refilling the patient with fresh dialysate (including sampling). Between t3 and t8, the dialysate remains in the patient, interrupted by sampling at time t6 and the action instructions to the patient to walk a few steps. The filling volume in the peritoneal space increases due to the removal of water from the patient. At time t8, the peritoneal space is then emptied again (while the patient is sitting), while samples of blood and dialysate are taken. Ultimately the patient is supplied with fresh dialysate, from which a sample is taken again.

Analysis of the samples of dialysate and blood in combination with the typical course of the PE test as shown in diagram 40 makes it possible to determine the filter function of the abdominal wall and/or the residual kidney function of the patient and thereby obtain information about the optimal dialysis prescription for a specific patient.

Two aspects of the present invention are illustrated in the diagram 40. The determination of the phases of the PE test, i.e., how much dialysate should be introduced into and/or pumped out of the peritoneal space, the sampling of blood and dialysate and the action instructions to the patient with the overall chronological sequence of these phases can be converted into a corresponding phase list in the frontend by means of a simple parameter key parameter value pair, for example, “pet_short(event_name)” because the sequence is standardized for a short PE test and a long PE test. In addition, the parameter value “event_name” which may refer to a communication phase as already described above, makes it possible to include the patient through instructions directed to the patient which can be output.

In addition, further information about the patient and/or about the treatment of the respective patient can be obtained by the fact that feedback of all types (for example, text entries or sound and/or video recordings) can be input by the patient during the communication phase in the manner described above and these acknowledgements can then be filed in such a manner that they are assigned to the respective patient.

The preparation, control and programming of medical treatment devices become more convenient and more flexible with the present invention. In addition, the invention allows the testing and simulation of medical treatment without endangering the patient.

1. A method for preparing medical treatment devices, characterized by the process steps:
selecting a frontend from a variety of frontends kept on hand, input of a prescription into the selected frontend,
generating a phase list from a prescription that has been input and can be read by the medical treatment device and then programs the sequence of a treatment.

2. The method according to claim 1, characterized in that the plurality of frontends differ in at least one feature from a plurality of features, such that the features may comprise the type of medical treatment device, the purpose of the treatment, the location of the treatment and/or the user of the frontend.

3. The method according to claim 1, characterized in that the phase list is transmitted to the treatment device.

4. The method according to claim 1, characterized in that the phase list comprises a communication phase.

5. The method according to claim 4, characterized in that information can be output from the medical treatment device and input to it during the communication phase.

6. The method according to claim 5, characterized in that the information comprises text, acoustic or visual information.

7. The method according to claim 1, characterized in that the treatment sequence includes generating a medical report.

8. The method according to claim 1, characterized in that a prescription is entered into the selected frontend by selecting graphic symbols.

9. The method according to claim 1, characterized in that parameter keys and parameter values can be input in the frontend such that the parameter values may comprise at least one of the variables: time, volume, concentration, active ingredient, temperature, conductivity, pressure, flow rate or text.

10. The method according to claim 9, characterized in that a parameter key describes a standardized medical test.

11. The method according to claim 10, characterized in that the standardized medical test is a PE test.

12. The method according to claim 1, characterized in that the frontend checks on whether the prescription that has been entered would endanger the health of a patient.

13. The method according to claim 1, characterized in that the frontend is equipped to simulate the treatment described by the prescription.

14. The method according to claim 1, characterized in that the medical treatment device is a blood treatment device.

15. The method according to claim 14, characterized in that the blood treatment device is a machine for automatic peritoneal dialysis.

16. A device for controlling medical treatment devices, comprising a microprocessor unit, an input device, an interface for technical data communication with external memory media or medical treatment devices, such that the microprocessor unit, the input device and the interface are interconnected for technical data transmission,
characterized in that the microprocessor unit is programmed for performing a method with the following method steps:
selecting with the help of the input device a specific frontend for the treatment and the treatment device from a plurality of frontends kept on hand,
input or selection of a prescription into or from the selected frontend with the help of an input device,
generating a phase list from the prescription thereby input, which can be read by the medial treatment device and which then programs the sequence of a treatment.

17. A system comprising a medical treatment device and a device for controlling the medical treatment device, said device for controlling the medical treatment device comprising a microprocessor unit, and input device, an interface for technical data communication with external memory media or medical treatment devices, such that the microprocessor unit, the input device and the interface are interconnected for technical data transmission,
characterized in that the microprocessor unit is programmed for performing a method comprising the following method steps:
selecting, with the help of the input device, a specific frontend for treatment and the treatment device from a plurality of frontends kept on hand,
input of a prescription into the selected frontend or selection of a prescription therefrom with the help of the input device, generating a phase list from the prescription thereby input, such that the phase list can be read-by the medical treatment device and then programs the sequence of a treatment.

18. A device according to claim 16, characterized in that the medical treatment device is a blood treatment device.

19. The device according to claim 18, characterized in that the blood treatment device is a machine for automatic peritoneal dialysis.

20. A computer program product consisting of a memory medium and a computer program stored on the memory medium for performing the method according to claim 1 when the computer program product is operated on a microprocessor.
